(19) United States
(12) Patent Application Publication
(10) Pub. No.: US 2011/0115254 A1
(43) Pub. Date: May 19, 2011

(54) APPARATUS FOR REDUCING DRAG ON VEHICLES WITH PLANAR REAR SURFACES

(76) Inventor: Joseph Skopic, Bloomsberg, PA (US)

(21) Appl. No.: 12/958,044

(22) Filed: Dec. 1, 2010

Related U.S. Application Data
(63) Continuation-in-part of application No. 12/398,643, filed on Mar. 5, 2009.

(51) Int. Cl. B62D 35/00

(52) U.S. Cl. 296/180.3

(57) ABSTRACT

Vanes are used for reducing drag on a first vehicle having a substantially planar rear surface, where the first vehicle is used to tow an unpowered second vehicle. Rigid brackets or braces may be used to mount vanes to the first vehicle. The apparatus is extremely light weight, and includes a rigid vane of length L having a leading edge and a trailing edge. The vane has an inner surface facing the vehicle and an outer surface. A first rigid bracket or brace and a second rigid bracket or brace may connect the upper and lower ends of the vane to a side surface of the first vehicle, respectively. The vane prevents or reduces formation of a zone of turbulent air between the first and second vehicles by directing airflow away from an airspace between the first and second vehicles. The apparatus allows substantial reductions in fuel consumption. The apparatus also reduces tractor CO₂ emissions during use as a result of reduced fuel consumption.

### CROSS-REFERENCE TO RELATED APPLICATIONS

This application is a continuation-in-part application of U.S. application Ser. No. 12/398,643, filed on Mar. 5, 2009.

### BACKGROUND OF THE INVENTION

1. Field of the Invention

The invention relates generally to devices for reducing air flow resistance and drag on trucks, semitrailers, railway cars, and other vehicles. More particularly, the invention relates to devices for redirecting air from airstreams passing around a vehicle into zones of turbulent air at the rear of the vehicle.

2. Description of the Prior Art

The profitability of long-distance highway cargo transport depends heavily on the cost of fuel, and on the efficiency with which the fuel is utilized. The cost of fuel is largely outside the control of the cargo transporter; however, the efficiency of fuel utilization may be increased. One method involves reducing resistance to forward motion of a vehicle through the air, Resistance to vehicular motion takes two major forms. First, the volume of air immediately in front of the vehicle acts as a barrier. A vehicle is then required to expend energy to push this volume of air aside, thereby reducing fuel economy. Significant advances have been made in aerodynamic design of semitrailer tractors and trailers, including the incorporation of deflectors to redirect air around substantially vertical planar surfaces of vehicles. A commonly used deflector takes the form of a dome-shaped device mounted on the top of a semitrailer tractor cab; the dome deflects air upward toward the top of the trailer, rather than allowing the air to flow directly against the vertical front of the trailer. Resistance to forward motion of the vehicle from the body of air in front of the vehicle is reduced. A measurable increase in the efficiency of fuel utilization, and a concomitant increase in mileage traveled per gallon of fuel used (fuel mileage), is obtained.

A second, and at least equally pernicious, form of resistance to a vehicle in motion lies in the drag on the vehicle caused by the formation of turbulent zones at the rear of the vehicle, or in between units of a combination vehicle, such as a string of multiple trailers. The airstreams passing over the top and along the sides of the vehicle recombine behind the vehicle. However, due to turbulence caused by the passage of the vehicle, a space filled with low pressure air forms between the rear of the vehicle and the point at which these airstreams fully recombine. This zone of turbulent air causes drag on the vehicle in a backward direction. The work that must be performed by the engine to pull the vehicle forward is then increased, thereby decreasing fuel mileage.

Aerodynamic drag on vehicles has long been recognized in the art. It has been determined that, for a tractor-trailer weighing 80,000 pounds travelling at 70 miles per hour, 65% of the energy expended by the vehicle is used to overcome aerodynamic drag. Of this 65% of the energy expended by the vehicle, 80% is expended to overcome drag forces at the rear of the vehicle. A number of solutions to this problem have been proposed. One common solution lies in streamlining the rear of a trailer. Airstreams passing along the trailer flow together more smoothly, resulting in reduced turbulence and a marked reduction in drag. However, a number of legacy trailers exist; which would require a sizable expense to replace. Accordingly, methods of reducing drag which may be easily and inexpensively retrofitted onto existing trailers would be attractive to trucking companies.

One method of retrofitting existing trailers with streamlined drag-reduction devices lies in the use of conical or pyramidal devices on the rear of a trailer. Such vanes act in the same manner as the streamlined rear of a trailer as described above, in that the conical or pyramidal devices allow airstreams to flow together more smoothly. An advantage over the above streamlined trailers is that conical or pyramidal devices may be readily retrofitted onto an existing, non-streamlined, trailer. However, these devices do have certain drawbacks. When used with trailer trucks, these devices normally fit over the doors at the rear of the trailer. Thus, these devices may not be simply mounted on a trailer and left in place. Instead, these devices must be assembled and mounted on the rear of the trailer after completion of the loading process. Similarly, such devices must be disassembled and removed from the trailer before unloading can begin, causing inconvenient delays in the unloading and loading processes. More importantly, at least some of the savings from increases in fuel mileage or fuel economy may be offset by increased hourly costs for labor. Another drawback of using rear-mounted devices on trailers is that the devices add significantly to the length of a trailer, making it difficult to use these conical or pyramidal devices to reduce drag in between a pair of trailers mounted in series.

Some designs allow the vanes to slide into or out of tracks mounted on the side of the vehicle; while the use of such tracks accelerates the process of positioning vanes after loading and unloading the trailer, the cost and complexity of retrofitting an existing trailer with a streamlined vane is significantly increased.

A second method of retrofitting trailers with a drag-reducing device lies in fitting vanes to the rear corners of the trailers. Corner vanes redirect airstreams passing along the sides of the vehicle to redirect flow behind the trailer. This reduces the magnitude of the turbulence behind the trailer, and hence reduces the drag on the vehicle. If two trailers are connected in series, formation of a turbulent zone between the trailers may be prevented by mounting vanes to the rear of the front trailer, such that air flowing along a front trailer is redirected away from the space between the front trailer and rear trailer.

Use of planar boattail plates rigidly mounted to the rear surface of the vehicle has been shown to produce a 20% reduction in drag forces with a significant increase in fuel savings. These plates extend outwardly from the rear surface of the vehicle. They help to prevent air travelling along the side of the vehicle from entering a region of low pressure air immediately behind the rear surface of the vehicle. However, in the case of a vehicle having hinged doors, these boattail plates impede the doors from swinging open. Accordingly, the plates must be manually removed or adjusted by the driver to allow the door to swing fully open. In the case of a vehicle having a roll-up door, these boattail plates impede the vehicle from backing up to a loading dock. Thus, the plates must be again be manually removed or adjusted by the driver to during loading or unloading operations. As a result, boattail plates have not achieved wide acceptance.

Many vanes of the prior art are rigidly mounted to the rear corners of a trailer. While these do an effective job of preventing drag, they do impede opening the doors on the rear of the trailer. Many trailers are designed with doors that open so as to lie flat against the side of the trailer, so as to allow the trailer to be loaded or unloaded in a small or enclosed space. However, the vanes, when rigidly mounted to the trailer, prevent the doors from opening completely. The inability to fully open the vehicle doors is a problem during the loading/unloading process, particularly when backing into docks that are located in confined spaces.

### SUMMARY

In light of the present need for an improved drag reduction apparatus for a vehicle, a brief summary is presented. Some simplifications and omission may be made in the following summary, which is intended to highlight and introduce some aspects of the various embodiments disclosed herein, but not to limit its scope. Detailed descriptions of a preferred exemplary embodiment further enabling those of ordinary skill in the art to make and use the invention concepts is presented in later sections.

Various embodiments disclosed herein relate to an apparatus for affecting airflow around a first moving vehicle towing a second vehicle, where the first moving vehicle has a substantially planar rear surface. In various embodiments, the apparatus comprises

a) a rigid vertical vane having a leading edge, a trailing edge, and an inner surface;

b) at least one first support connecting an upper end of the inner surface of the vane to a side surface of the first vehicle; and

c) at least one second support connecting a lower end of the inner surface of the vane to the side surface of the first vehicle.

The vane reduces or prevents formation of a volume of turbulent air between the first and second vehicles. In various embodiments, the first and second supports rigidly connect the side surface of the first vehicle to the vane. In various embodiments, one vane is mounted on each side of the vehicle.

In various embodiments disclosed herein, the rigid vertical vane on the side surface of the first vehicle is a cambered vane having a leading edge, a trailing edge, a curved inner surface, and a flat outer surface. The outer surface has a leading portion and a trailing portion, where the leading portion and the trailing portion intersect at an angle α, said angle α being between 0° and 10°. The cambered vane has a chordline H where the chordline H makes an angle γ with the side surface of the first vehicle, said angle γ ranging from 0° to 10°, preferably from 2° to 8°, more preferably from 3° to 7°. Angle γ may also be viewed as an angle between chordline H and an airflow flowing along said side surface of said first vehicle. In various embodiments, the cambered vane diverts said airflow away from said side surface of said first vehicle. In various embodiments, the angle γ is adjustable. In other embodiments, angle γ between the chordline H and the airflow is fixed, and is not adjustable. In other embodiments disclosed herein, the rigid vertical vane on the side surface of the first vehicle is a non-cambered or symmetrical vane having a leading edge, a trailing edge, an inner surface, and an outer surface.

In various embodiments, the first moving vehicle is a powered vehicle and the second moving vehicle is a non-powered vehicle. In such embodiments, the first moving vehicle may a tractor, while the second vehicle is a trailer. In other embodiments, the first moving vehicle and the second moving vehicle are each non-powered vehicles, and may be either towed or pushed by a third powered vehicle. In such embodiments, the first moving vehicle and the second vehicle may each be railroad cars being towed or pushed by a locomotive. In further embodiments, the first moving vehicle is a non-powered vehicle and the second moving vehicle is a powered vehicle which pushes the first vehicle.

Various embodiments relate to an apparatus for affecting airflow around a first moving vehicle towing or being pushed by a second vehicle. The first moving vehicle has a substantially planar rear surface. The apparatus comprises a rigid horizontal vane having a leading edge, a trailing edge, and a lower surface; and at least one support connecting said lower surface of said vane to a top surface of said first vehicle. The vane reduces or prevents formation of a volume of turbulent air above the rear surface of the first moving vehicle.

### BRIEF DESCRIPTION OF THE DRAWINGS

In order to better understand various embodiments of the invention, reference is made to the accompanying drawings, wherein:

FIG. 1 shows the pattern of air flow around a prior art vehicle having a generally planar rear surface, and illustrates how drag forces arise;

FIG. 2 shows the prior art use of vanes to modify the pattern of air flow around a vehicle having a generally planar rear surface so as to reduce the magnitude of drag forces;

FIG. 3 shows how prior art vanes interact with a set of doors on the rear surface of a vehicle;

FIG. 4 shows a vane for reduction of drag, as described in the present disclosure (Please note that the vane and the truck are not necessarily drawn to scale in these figures.);

FIG. 5 shows a first method of connecting a series of pliant flexible attachments to a vane of the present disclosure;

FIG. 6 shows an alternative method of connecting pliant flexible attachments to a vane of the present disclosure;

FIG. 7 shows the vanes of FIG. 4 connected to a vehicle having a generally planar rear surface with right and left rear doors;

FIG. 8 provides an exploded view showing a method of connecting a vane to a vehicle by means of a pliant flexible attachment;

FIG. 9a shows the pattern of air flow around a vehicle lacking vanes as described in the present disclosure;

FIG. 9b shows the pattern of air flow around a vehicle of FIG. 7 having vanes according to the present disclosure;

FIGS. 10a, 10b and 10c show the effect of opening the rear door of a vehicle having vanes as described in the present disclosure attached thereto on the positioning of the vanes;

FIG. 11 shows a method of connecting a vane to a vehicle having a single rear door by means of flexible pliant flexible attachments;

FIG. 12 shows a top view of a vane connected to a vehicle having a single rear door by means of flexible pliant flexible attachments;

FIG. 13 shows a top view of the pattern of air flow around a prior art tractor towing a trailer, where the tractor has a cab with generally planar rear surface, and illustrates how drag forces arise due to turbulent air between the truck and the trailer;

FIG. 14 shows a vane for reduction of drag, designed to be mounted on a side of a tractor of FIG. 13 towing a trailer, as described in the present disclosure;

FIG. 15 shows a rear view of a tractor having vanes of FIG. 14 mounted thereon;

FIG. 16 shows a top view of the pattern of air flow around a tractor towing a trailer of FIG. 13, where the tractor has been modified to include according to the present disclosure;

FIG. 17 shows a vane for reduction of drag, designed to be mounted a top surface of a tractor of FIG. 13 towing a trailer, as described in the present disclosure;

FIG. 18 shows a rear view of a tractor having vanes of FIG. 14 mounted thereon; and

FIG. 19 shows a top view of the pattern of air flow around a tractor towing a trailer of FIG. 13, where the tractor has been modified to include according to the present disclosure.

### DETAILED DESCRIPTION

The term “aerodynamic center,” as used in this disclosure, may be defined as, but is not limited to, the point at which the pitching moment coefficient for a vane or airfoil does not vary with lift coefficient. For symmetric vanes or airfoils moving through an airflow, the aerodynamic center of the vane is located approximately 25% of the length of the chordline of the vane from the leading edge of the vane (the quarter-chord point). The chordline extends from the leading edge of the airfoil to the trailing edge of the vane or airfoil. For non-symmetric (cambered) vanes, the quarter-chord is only an approximation for the aerodynamic center.

The term “tractor,” as used in this disclosure, may be defined as, but is not limited to, a motor-driven vehicle used for pulling heavy machinery or other vehicles. In various embodiments, the term “tractor” relates to a truck tractor; i.e., a short truck with a driver's cab but no body, designed for hauling a trailer or semitrailer.

The term “truck,” as used in this disclosure, may be defined as, but is not limited to, the combination of a tractor and a trailer or semitrailer.

The term “vehicle,” as used in this disclosure, may be defined as, but is not limited to, any powered or unpowered moving vehicle. Accordingly, “vehicle,” as used in this disclosure, may relate to, but is not limited to, a tractor, the combination of a tractor and a trailer, a trailer, a railway car, etc.

The terms “vane” and “airfoil,” as used in this disclosure, may be defined as, but are not limited to, any cambered or non-cambered surface, designed to affect airflow by diverting air currents through which the vane or airfoil moves. A vane or airfoil according to this disclosure may be connected to a vehicle by cables or by a rigid bracket. The cables or brackets may be, but are not required to be connected to the ends of the vane or airfoil. In the context of this disclosure, an end of a vane or airfoil is an end portion near the terminus of the vane, the end portion having a length of up to 20% of the total length of the vane.

FIG. 1 shows a prior art airflow around a vehicle 100. such as a trailer, having a generally planar rear surface 102, a right side 103, and a left side 104, when vehicle 100 moves in a forward direction D at a desired speed. Under these conditions, air moves, relative to vehicle 100, along the sides 103 and 104 in the direction of arrows A and B, respectively. The flow of air in the direction A and the flow of air in the direction B do not reunite immediately behind rear surface 102; rather, airflows A and B reunite at a point at a certain distance R behind surface 102. A zone of low pressure turbulent air is thereby created behind rear surface 102, between the flow of air in the direction A and the flow of air in the direction B. This low pressure zone creates turbulence, and sucks air from air flows A and B in the direction of arrows C, into the zone of low pressure air. Airflow in the direction of arrows C somewhat increases the air pressure behind surface 102, but also increases the turbulence in this volume of air. As a result, as the vehicle moves forward in the direction of arrow D, a volume of turbulent air is carried behind vehicle 100. This volume of turbulent air creates drag on the vehicle by creating suction on surface 102, where the suction creates a retarding force of drag in the direction of arrow E. The engine causing the vehicle to move forward must work harder to cause the vehicle to move at the desired speed in direction D while simultaneously overcoming the retarding force in the direction of arrow E.

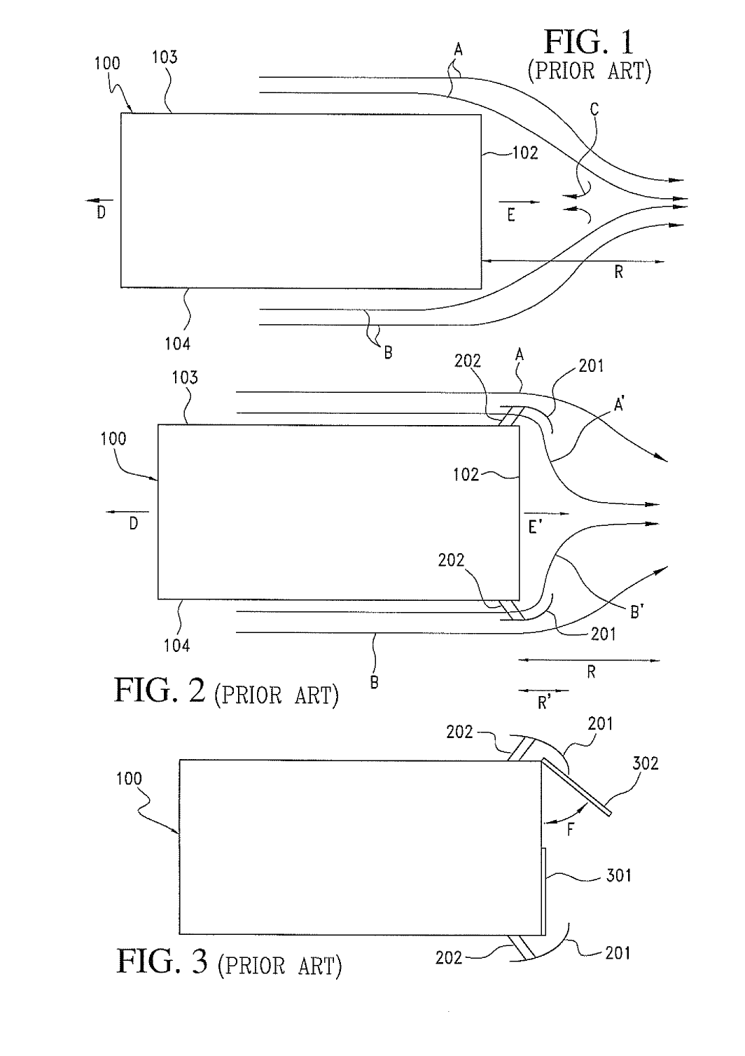

FIG. 2 shows a prior art method of reducing drag on a vehicle by connecting vanes 201 to the rear of the vehicle using brackets 202. When vehicle 100 moves in a forward direction D, a leading edge of a first vane 201 captures a portion of the airflow in direction A along right side 103, and the trailing edge of the first vane redirects the captured airflow in a new direction A′. The other vane 201 redirects a portion of the airflow in direction B along left side 104 in a new direction B′ in a similar fashion. The remainder of the airflows in directions A and B proceed as described above, reuniting at distance R behind surface 102 and forming a turbulent zone of air. The airflows in direction A′ and direction B′, after leaving vanes 201, flow directly into this zone of turbulent air behind surface 102, and reunite at a distance R′ behind surface 102, where distance R′ is less than distance R. This reduces turbulence behind surface 102, and reduces the extent of the drag exerted on the vehicle in the direction of arrow E′ by the volume of turbulent air.

FIG. 3 shows prior art vanes 201 attached to the rear edges of vehicle 100, where vehicle 100 has doors 301 and 302 in its rear surface. The vanes are attached using rigid brackets 202 to hold the vanes in position. Vanes which have been rigidly attached in this fashion at the rear of a trailer can cause problems when the vehicle doors are opened. These doors typically swing open or closed in the direction of arrow F to facilitate loading and unloading of the vehicle. When vanes 201 are rigidly held in position by brackets 202, the vanes prevent the door from fully opening in the direction of arrow F, complicating the loading/unloading process.

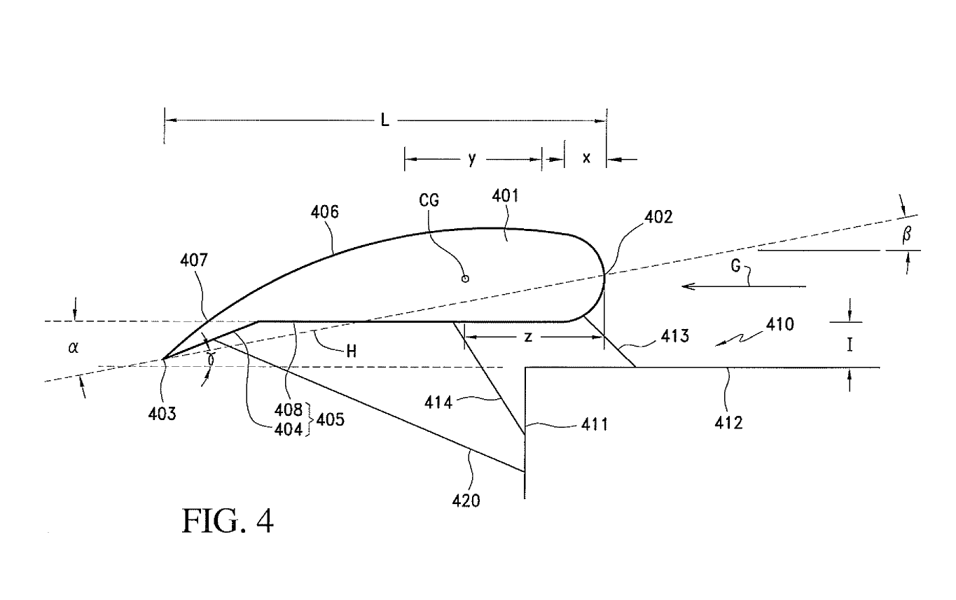

Various embodiments disclosed herein overcome this difficulty by attaching vanes to a truck using novel pliant or flexible attachment means, where the terms “pliant” and “flexible” are used in this disclosure as synonyms. One embodiment of the invention, shown in FIG. 4, includes a cambered vane of length L, where the vane is attached to the vehicle by pliant attachment means described in greater detail below. The cambered vane is referred to by the reference number 401, with each individual part of the vane being given a separate reference number. Vane 401 has a leading edge 402 and a trailing edge 403, a curved upper surface 406, and an inner surface 405. Length L is between 3 and 10 inches, preferably between 4 and 6 inches. Vane 401 has an aerodynamic center CG, where CG is positioned a defined distance Z behind leading edge 402, where Z is greater than 0.15 L and less than 0.5 L, preferably between 0.35 L and 0.2 L, more preferably between 0.23 L and 0.3 L, most preferably about 0.26 L. Inner surface 405 also includes a leading portion 408 and a trailing portion 404. Leading portion 408 and trailing portion 404 intersect with a defined angle of deflection α. Angle α is between 0° and 10°, preferably between 0° and 7°. Chordline H is defined by a line between the leading edge 402 of vane 401 and the trailing edge 403 of vane 401. When the vane is directed into an airflow in direction G, the angle between the chordline H and airflow G is defined by angle β. The vane 401 is preferably positioned so that the angle β ranges from a minimum of 0° (i.e., chordline H is parallel to airflow G) up to about 10°. Preferably, the angle β ranges from 0° up to about 5°. More preferably, the angle β ranges from 0° up to about 4°.

Again as shown in FIG. 4, the vane 401 is positioned on a vehicle 410 having a generally planar rear surface 411 and a side surface 412. The vane 401 is positioned so that vane 401 extends behind the rear vehicle surface 411, with the forward edge of planar inner surface 405 of vane 401 being adjacent to side vehicle surface 412, with a defined distance I separating surfaces 405 and 412. In one embodiment, the vane 401 is oriented so that chordline H makes an angle γ with the vehicle ranging from a minimum of 0° (i.e., chordline H is parallel to airflow G) up to about 10°. Preferably, the angle γ ranges from 2° up to about 8°. More preferably, the angle ranges from 3° up to about 7°. In a second embodiment, the vane 401 is oriented so that surface 405 is parallel to side vehicle surface 412. The inner surface 405 of vane 401 is preferably about 0.25 to 2.0 inches from the surface 412 of the vehicle, more preferably from 0.3 to 1.0 inch (identified as distance I).

Again as shown in FIG. 4, the vane 401 is connected to vehicle 410 by at least one first pliant attachment means 413 connecting the leading edge 402 of the vane 401 to the side surface 412 of the vehicle. First pliant attachment means 413 is connected at one end to side surface 412, and at the other end to the leading edge 402 of the vane 401. Specifically, for the purposes of this application, connection to the leading edge 402 of the vane 401 means connection to the inner surface of the vane at a distance of less than or equal to X from the forwardmost point of the leading edge 402 of the vane 401, where X is 0.1 L. Vane 401 is also connected to vehicle 410 by at least one second pliant attachment means 420 connecting the trailing edge 403 or inner surface portion 404 of the vane 401 to the rear surface 411 of the vehicle. Second pliant attachment means 420 is connected at one end to rear surface 411, and at the other end to the trailing edge 403 or inner surface portion 404 of the vane 401. The pliant attachment means may be ropes, cables, or nylon straps.

Again as shown in FIG. 4, the vane 401 is also connected to vehicle 410 by at least one third pliant attachment means 414 connecting the vane 401 to the vehicle. In one embodiment, the third pliant attachment means 414 is connected to said inner surface of vane 401 at a distance of between 0.15 L and 0.5 L from the leading edge of said vane, preferably at a distance of between 0.15 L and 0.35 L from the leading edge of said vane, more preferably at about 0.26 L. from the leading edge of said vane. In a further embodiment, the third pliant attachment means is connected to the inner surface of the vane at the aerodynamic center CG of the vane 401. A door may be present in the rear surface of the vehicle, and the at least one second pliant attachment means may connect the trailing edge of the vane to the door. In certain embodiments, third pliant attachment means 414 connects the vane 401 to the rear surface of the vehicle. If third pliant attachment means 414 and second pliant attachment means 420 each connect to the rear surface of the vehicle, they may connect to different points on the rear surface of the vehicle, as shown in FIG. 4; or to the same point on the rear surface of the vehicle. Typically. one vane is attached to each side of the vehicle in the manner described.

To avoid adding excess weight to the vehicle, the total weight of the vanes and the various ropes, cables, nylon straps, or other pliant attachment means may be less than 100 pounds, preferably less than fifty pounds, most preferably less than 20 pounds.

The first pliant attachment means 413 extends from the leading edge 402 of the vane 401 forwards and connects to side surface 412 of the vehicle, as shown in FIG. 4. The length of attachment means 413 controls the horizontal distance between the trailing edge of the rigid vane and the rear surface of the vehicle. Increasing the length of attachment means 413 moves the trailing edge of the vane backwards, increasing the distance between the trailing edge of the vane and the rear surface of the vehicle.

The second pliant attachment means 420 extends from the trailing edge 403 or inner surface portion 404 of the vane 401 and connects to the rear surface 411 of the vehicle, as shown in FIG. 4. The length of attachment means 420 controls the angle γ between the side surface of the vehicle and the chordline H of the vane 401. Decreasing the length of attachment means 420 increases angle γ. Changing angle γ alters the angle at which air flows over the vane, relative to the side of the truck.

The third pliant attachment means 414 connects the inner surface 405 of the vane to the vehicle, as shown in FIG. 4. The length of the third pliant attachment means 414 controls the distance I between the inner surface 405 of the vane and the side surface of said vehicle. Adjusting the length of the third pliant attachment means 414 changes the volume of air in a stream of slower, high pressure air traveling between the inner surface of vane 401 and the side of vehicle 100. Additionally, shortening the length of attachment means 414 can alter the angle γ between the side surface of the vehicle and the chordline H of the vane 401 by moving the front of the vane closer to the vehicle.

Use of vanes according to various exemplary embodiments set forth in this disclosure can lead to significant savings in fuel consumption. In particular, depending on road conditions and prevailing winds, savings of approximately 5% to 20%, more particularly 5% to 15%, most particularly 7% to 15%, in fuel consumption can be achieved. Assuming a 10% reduction in fuel consumption, a reduction of up to 50 tons per truck per year in CO₂ emissions may be achieved.

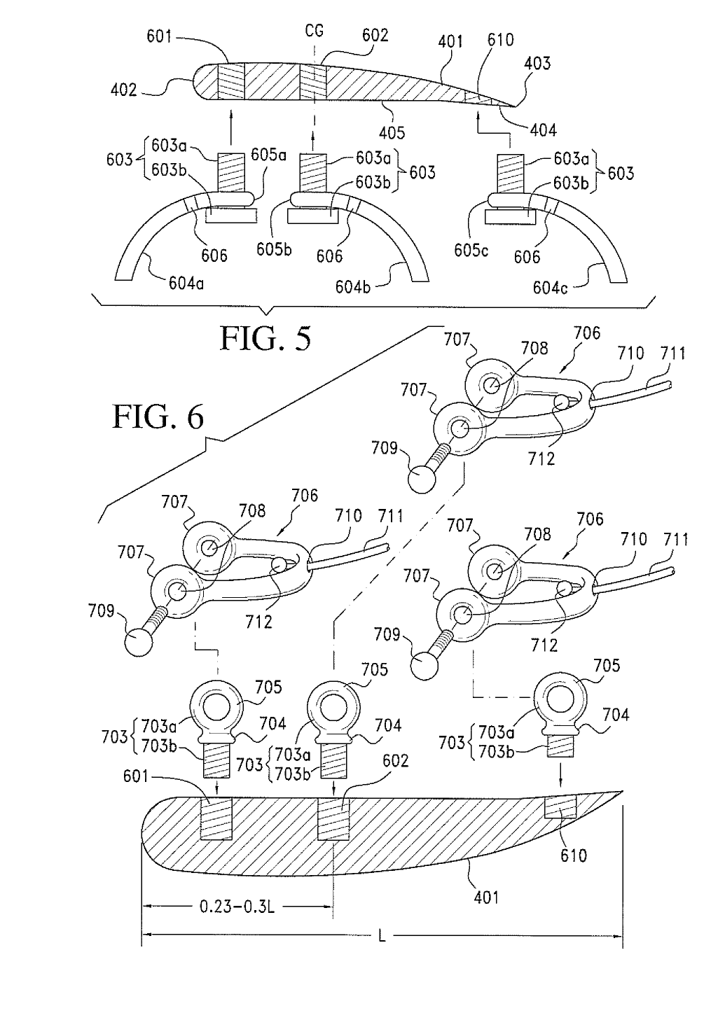

FIG. 5 shows a method of connecting cables or other pliant materials to vane 401 by providing threaded female joints through vane 401. As shown in FIG. 5, a first set of threaded female joints 601 may be positioned in the leading edge of vane 401, and a second set of threaded female joints 610 may be positioned in the trailing edge of vane 401. A third set of threaded female joints 602 may be positioned in the vane 401 at a distance of between 0.15 L and 0.5 L from the leading edge of the vane, preferably between 0.15 L and 0.35 L from the leading edge of the vane, most preferably between 0.23 and 0.3 L from the leading edge of the vane.

In another embodiment, threaded female joints 602 are positioned at the aerodynamic center CG of the vane, as shown in FIG. 5. Bolts 603 having threaded male shafts 603a and heads 603b are provided. A rope or cable 604a having a loop 605a at one end is connected to a bolt 603 by passing shaft 603a through loop 605a. Rope or cable 604a is connected to joint 601 by screwing shaft 603a into joint 601 at leading edge 402. A rope or cable 604c having a loop 605c at one end is connected to a bolt 603 by passing shaft 603a through loop 605c. Rope or cable 604c is connected to joint 610 by screwing shaft 603a into joint 610 at trailing edge 403. A third rope or cable 604b having a loop 605b at one end is connected to a bolt 603 by passing shaft 603a through loop 605b. Rope or cable 604b is connected to joint 602 by screwing shaft 603a into joint 602. Loops 605a, 605c and 605b are held between the inner surface 405 of the vane, and bolt heads 603b.

FIG. 6 shows use of another method of connecting cables or other pliant materials to vane 401 by providing threaded female joints through vane 401. As shown in FIG. 6, a first set of threaded female joints 601 may be positioned in the leading edge of vane 401, and a second set of threaded female joints 610 may be positioned in the trailing edge of vane 401. A third set of threaded female joints 602 may be positioned in the vane 401 at a distance of between 0.15 L and 0.5 L from the leading edge of the vane, preferably between 0.15 L and 0.35 L from the leading edge of the vane, most preferably between 0.23 and 0.3 L from the leading edge of the vane. In another embodiment, threaded female joints 602 are positioned at the aerodynamic center CG of the vane, as shown in FIG. 6. Eye bolts 703 having threaded male shafts 703a and ring-shaped heads 703b are provided. Each head 703b includes a shoulder 704 and a hole 705 therethrough. Each eye bolt 703 is screwed into one of joints 601, joints 602, or joints 610. A set of cable forks 706 are also provided. Each cable fork 706 is substantially U-shaped, and has two ends 707, where each end 707 has a hole 708 therethrough. Each cable fork 706 is positioned over an eye bolt 703 so that holes 708 in the cable fork coincide with hole 705 in the eye bolt so that holes 708 and 705 are aligned. A rivet 709 having a head and a shaft passes through this continuous passage, and is secured by mushrooming the end of the shaft. Preferably, cable fork 706 is able to pivot about an axis defined by the rivet. Cable fork 706 additionally includes a hole 710 at the center of the cable fork. Hole 710 has an axis which is perpendicular to the axis defined by the rivet. A cable 711 passes through hole 710 in cable fork 706. A bulb 712 holds cable 711 in position on the cable fork, connecting the cables to vane 401.

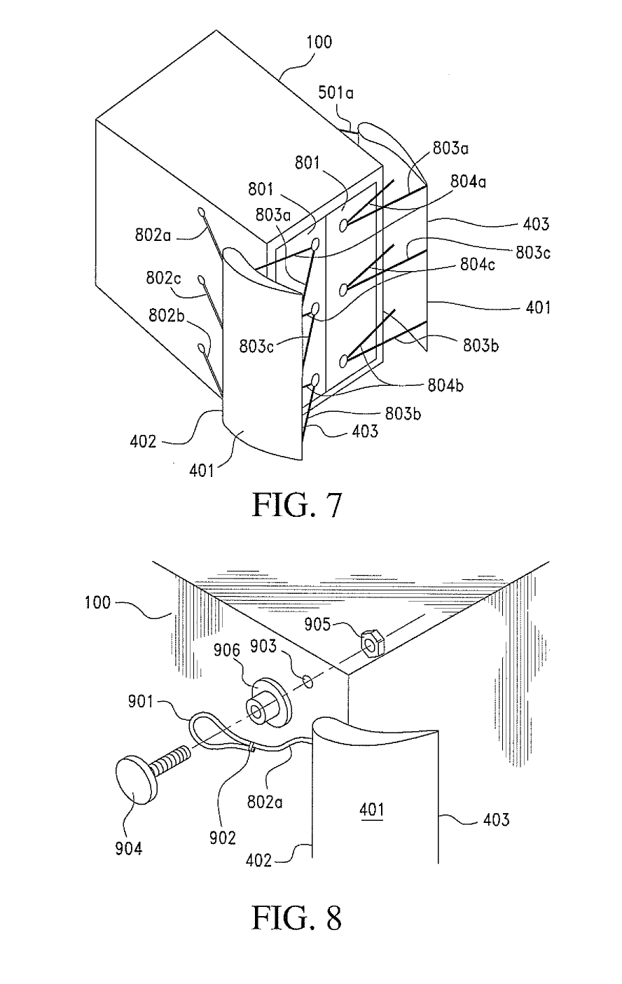

FIG. 7 and FIG. 8 illustrate one example of the manner in which the vanes are attached to a vehicle 100 having doors 801. This method may be performed on new vehicles or used to retrofit existing vehicles with vanes 401 with equal facility. As shown in FIG. 7, vehicle 100 has a left rear door and a right rear door. With the doors 801 in a closed position, the vanes are attached to the vehicle by connecting the leading edge 402 of a vane 401 to the left side of the vehicle 100. This may be done by fastening cable 802a or a similar pliant material from the upper end of leading edge 402 of vane 401 to the upper edge of the left side of vehicle 100. Similarly, cable 802b connects the lower end of the leading edge 402 of vane 401 to the lower edge of the left side of vehicle 100. Cable 802c connects a central portion of the leading edge 402 of vane 401 to a central portion of the edge of the left side of vehicle 100. Cable 803a or a similar pliant material extends from the upper end of trailing edge 403 of vane 401 to a door 801 on the rear surface of vehicle 100. Similarly, cable 803b connects the lower end of the trailing edge 403 of vane 401 to a door 801 on the rear surface of vehicle 100. Cable 803c connects a central portion of the trailing edge 403 of vane 401 to a central portion of the rear surface of vehicle 100. The inner surface 405 of vane 401 is then connected to the right side of the rear surface of vehicle 100 by connecting cables 804a, 804b, and 804c. In a preferred embodiment, cables 804a, 804b, and 804c are connected to a hinged door 801 in the rear surface of vehicle 100. A second vane 401 is attached to the vehicle by connecting the leading edge 402 of a vane 401 to the left side of the vehicle 100, connecting the trailing edge 403 of the second vane 401 to the rear surface of the vehicle 100, and connecting the inner surface 405 of the second vane 401 to the right side of the rear surface of vehicle 100.

The cables are connected to vehicle 100 as shown in FIG. 8, which illustrates connection of cable 802a extending from the upper end of the leading edge 402 of vane 401: all cables are connected similarly (Please note that the top of vehicle 100 is not shown in FIG. 8, for reasons of clarity.). For the purposes of this discussion, the cables are shown as being attached to vane 401. A loop 901 is formed at the end of each cable 802a and secured with a clamp 902 so that loop 901 may be positioned over grommet 906. A hole 903 is then drilled in the side of vehicle 100, and the cable loop 901 is secured to the vehicle by passing a bolt 904 through grommet 906 and hole 903, and securing the bolt in position using nut 905. The head of bolt 904 must be larger than loop 901. The grommet 906 must be positioned with the largest diameter surface flat against the side of vehicle 100. After assembly, a check may be performed to be sure the flexible cable rotates freely and the loop cannot slip over the bolt head. In a preferred embodiment, free rotation of the flexible cables around the grommets allows the vanes to be positioned properly when the doors are fully opened. This assembly installation procedure may be used on all fastened connections to the vehicle 100.

Since the cables are flexible, when vehicle 100 is stationary and doors 801 are closed, the vanes tend to hang loosely from the cables and rest against the rear corner edges of vehicle 100.

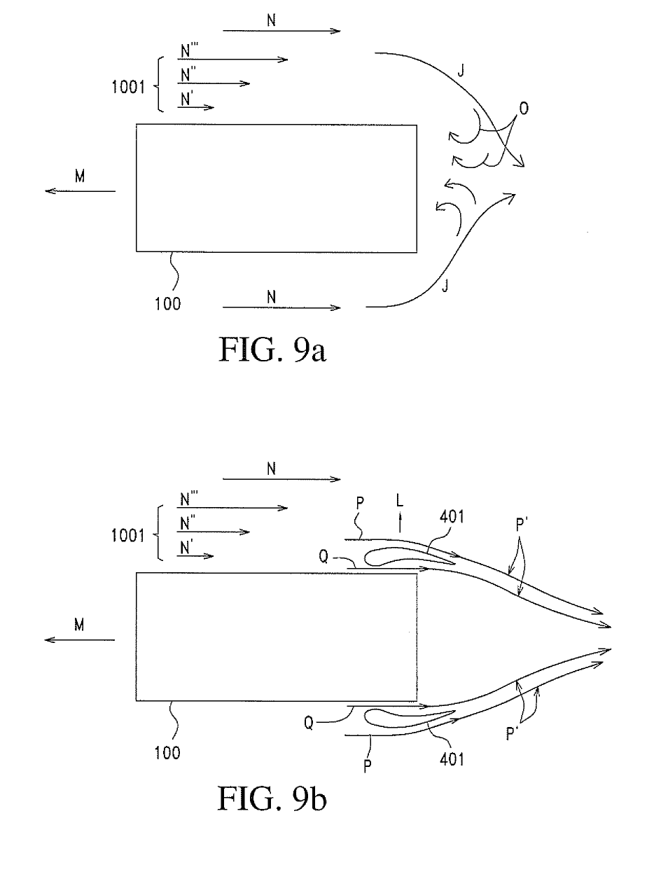

FIG. 9a shows vehicle 100 in motion in the direction of arrow M. in the absence of vanes 401. Under such conditions, air flows along the sides of vehicle 100 in the direction of arrow N at a defined velocity n. Near the surface of vehicle 100 is a boundary layer 1001, where air flows at a variable velocity. Near the surface of the vehicle, air flows along the sides of vehicle 100 in the direction of arrow N′ at a defined velocity n′ which is less than n. In the middle of the boundary layer, air flows along the sides of vehicle 100 in the direction of arrow N″ at a defined velocity if which is less than n, but greater than n′. At the outer edge of the boundary layer, air flows along the sides of vehicle 100 in the direction of arrow N″′ at velocity n, equal to the velocity of the airflow outside the boundary layer. Additionally, the pressure at the front of vehicle 100 is greater than the pressure at the back of vehicle 100, creating pressure drag. At the rear of the truck, air flowing along the sides of the truck flows into the region of low pressure air behind the truck in the direction of arrows J. The twin airflows in the direction of arrows J meet behind the rear surface of the truck, relatively close to the rear surface of the truck. At least a portion of the air flowing in the direction of arrow J is sucked into the low pressure zone immediately behind the vehicle, creating a zone of turbulent air in the direction of arrows O behind the rear surface of the vehicle. Additionally, the velocity differential between the boundary layer and stream N can add to turbulence as the airflow reaches the rear surface of vehicle 100.

FIG. 9b shows a vehicle 100 having vanes 401 mounted thereon in motion in the direction of arrow M. Under such conditions, air flows along the sides of vehicle 100 in the direction of arrow N at a defined velocity n. Near the surface of vehicle 100 is a boundary layer 1001, where air flows at a variable velocity. Near the surface of the vehicle, air flows along the sides of vehicle 100 in the direction of arrow N′ at a defined velocity n′ which is less than n. In the middle of the boundary layer, air flows along the sides of vehicle 100 in the direction of arrow N″ at a defined velocity n″ which is less than n, but greater than n′. At the outer edge of the boundary layer, air flows along the sides of vehicle 100 in the direction of arrow N″′ at velocity n″′, equal to the velocity of the airflow outside the boundary layer. As the airflow reaches vane 401, it divides into a stream P of fast, low pressure air traveling over the outer surface of vane 401, and a stream of slower, high pressure air Q traveling between the inner surface of vane 401 and the side of vehicle 100. The difference in velocity between stream P and stream Q creates a force causing the vane to move away from vehicle 100 in the direction of arrow L. Streams P and Q, unlike stream J in FIG. 9a, do not flow directly into the region of low pressure air immediately behind the truck. Rather, they flow along the surfaces of vane 401 and meet behind the trailing edge of vane 401. The resulting combined airstreams continue to flow in the direction of arrows P′ until they meet at a point which is significantly removed from the rear surface of the truck. Streams P′ thus flow together with little or no tendency for air from these airstreams to be sucked into the region of low pressure air behind the rear surface of the truck. As a result, little or no turbulence is formed behind the rear surface of the truck, dramatically reducing drag on the vehicle. The point at which streams P′ meet may be controlled by adjusting the distance between the side of the truck and vanes 401, and the angle γ between the side of the truck and vanes 401.

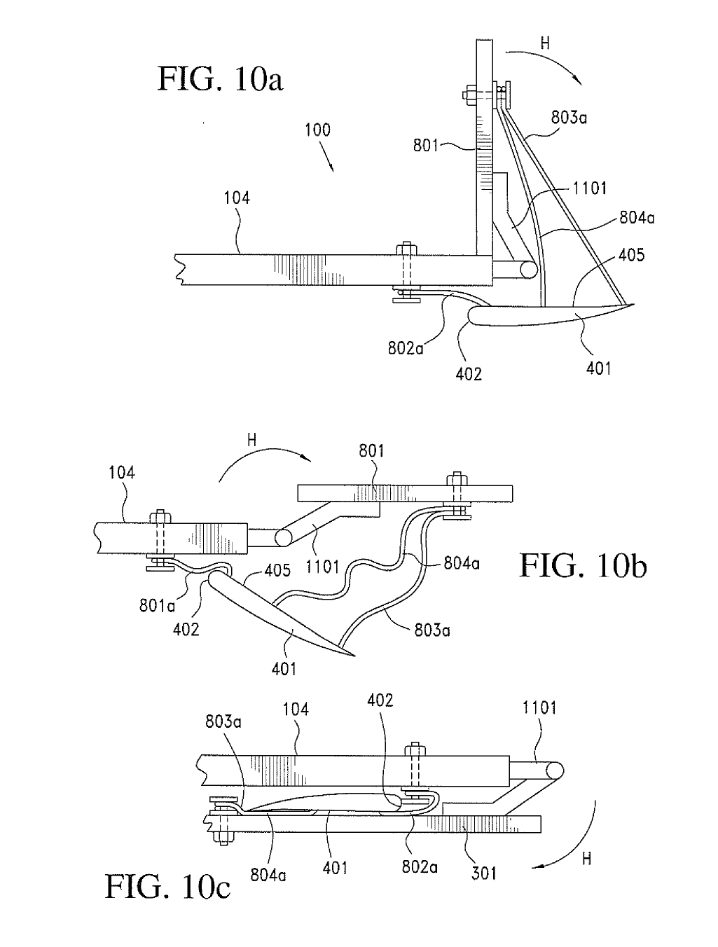

As shown in FIG. 10a, FIG. 10b, and FIG. 10c, the vanes 401, when mounted using a set of flexible cables, have the further benefit that the vanes 401 do not impede opening of the right and left rear doors 801, unlike prior art vanes mounted using rigid brackets. The flexible nature of the cables or other pliant attachment means connecting the vanes to the vehicles allows the vane to fold back out of the way as door 801 opens. In FIG. 10a, the upper end of vane 401 is secured to door 801 using cables 803a and 804a, and to side 104 of vehicle 100 using cable 802a (Cables connecting the central portion and lower end of the vane to the vehicle, although needed to properly secure the vane to the vehicle, are omitted for clarity). Cable 802a connects the leading edge 402 of vane 401 to side 104 of vehicle 100. Cable 803a connects the trailing edge of vane 401 to door 801 of vehicle 100. Cable 804a connects the inner surface 405 of vane 401 to door 801 in the rear surface of vehicle 100. The inner surface 405 of vane 401 lies over hinge 1101, with the leading edge 402 of the vane extending over side 104 of the vehicle, and the trailing edge 405 of the vane extending behind vehicle 100.

As door 801 opens, it swings about hinge 1101 in the direction of arrow H, vane 401 swings away from the vehicle (FIG. 10b). As door 801 continues to swing in the direction of arrow H (FIG. 10c), the outer surface of vane 401 folds back against wall 104 of the vehicle, allowing the door 801 to be fully opened. In this position, the inner surface 405 of vane 401 lies against door 801. The ability of the vanes to fold against wall 104 greatly facilitates loading and unloading of the vehicle. It also reduces operator costs for labor, as there is no need to pay workers for time spent mounting and dismounting vanes during the loading/unloading process.

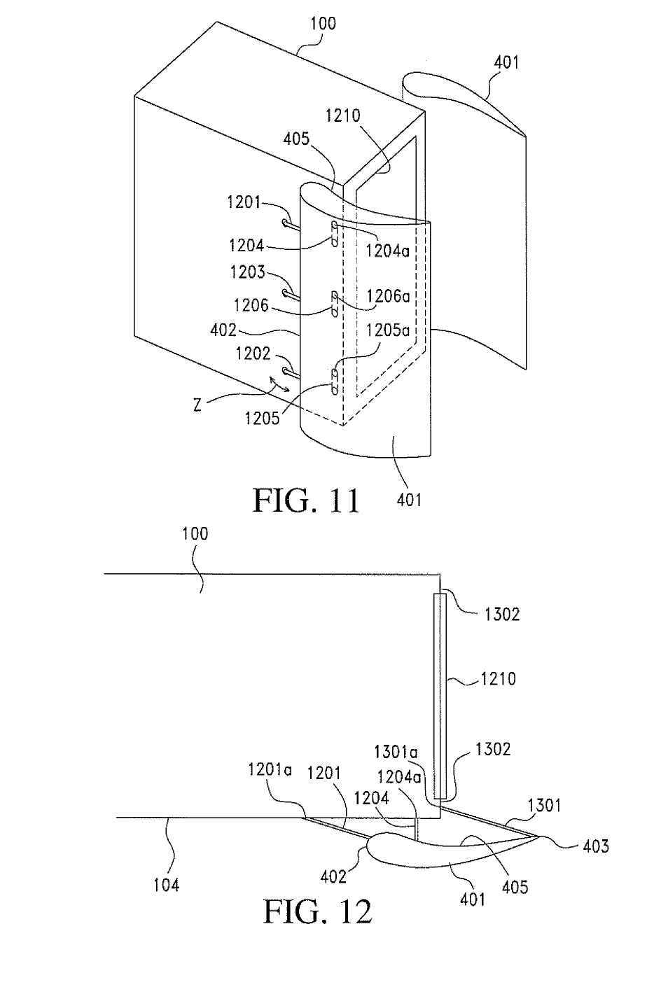

In another embodiment shown in FIG. 11, the vanes may be connected to a vehicle 100 having a rear surface with a door 1210 that is not hinged to swing outwardly, as in FIG. 10. For example, the vehicle may have a door 1210 that rolls up vertically. In any of these cases, connection of the vane 401 to door 1210 as shown in FIG. 8 can be still be done, but it is less preferred. This is because the necessary cable connections would preclude opening of the door without removing the vane. Accordingly, an alternate connection method is here described that allows vanes 401 to be mounted to a door 1210 that is not hinged to swing outwardly, shown in FIG. 11. As shown in FIG. 11, vehicle 100 has a single roll-up door 1210. With the door 1210 in a closed position, the vanes are attached to the vehicle by connecting the leading edge 402 of a vane 401 to the left side of the vehicle 100. This may be done by fastening cable 1201 from the upper end of leading edge 402 of vane 401 to the upper edge of the left side of vehicle 100. Similarly, cable 1202 connects the lower end of the leading edge 402 of vane 401 to the lower edge of the left side of vehicle 100. At least one cable 1203 connects a central portion of the leading edge 402 of vane 401 to a central portion of the edge of the left side of vehicle 100. If desired, multiple cables 1203 may be used. Preferably, cables 1201, 1202, and all cables 1203 are evenly spaced along the length of the vane, and all extend forward toward a front of vehicle 100. The inner surface 405 of vane 401 is then connected to the left side of the rear surface of vehicle 100 by fastening cable 1204 from the upper end of the inner surface 405 of vane 401 to the left side of vehicle 100. Cable 1204 preferably runs vertically in an upwards direction to a point of attachment 1204a on the rear edge of the left side of vehicle 100. Similarly, cable 1205 vertically connects the lower end of the inner surface 405 of vane 401 to a point of attachment 1205a on the rear edge of the left side of vehicle 100. At least one cable 1206 vertically connects a central portion of the inner surface 405 of vane 401 to a point of attachment 1206a on the rear edge of the left side of vehicle 100. Preferably, cables 1204, 1205, and all cables 1206 are each connected to the inner surface of vane 401 at the aerodynamic center of vane 401; or at a distance of 0.15 L to 0.5 L, preferably 0.15 L to 0.35 L, more preferably 0.26 L, where L is the length of the vane, from the leading edge of the vane. A second vane 401 is attached to the vehicle by connecting the leading edge 402 of a vane 401 to the right side of the vehicle 100, and connecting an inner surface 405 of the vane 401 to the right side of the vehicle 100 in the exact same way. Since neither vane is connected to door 1210, door 1210 can be opened without requiring removal of either or both vanes 401. The vane hangs from cables 1204, 1205, and 1206, allowing the cable to move reversibly in the direction of arrow Z.

In the embodiment of FIG. 11, vanes 401 hang downwardly from vertical cables 1204, 1205, and 1206. When the truck is at rest, vanes 401 are able to move reversibly in the direction of arrows Z on flexible cables 1204, 1205, and 1206. This allows vanes 401 to move out of the way in the direction of arrow Z without any involvement from the driver when the truck is backed up against a loading dock. Contact with a wall or ledge surrounding the loading dock pushes the vanes backwards in the direction of arrow Z, allowing the truck to back up against the loading dock without requiring the driver to manually adjust or dismantle the vanes.

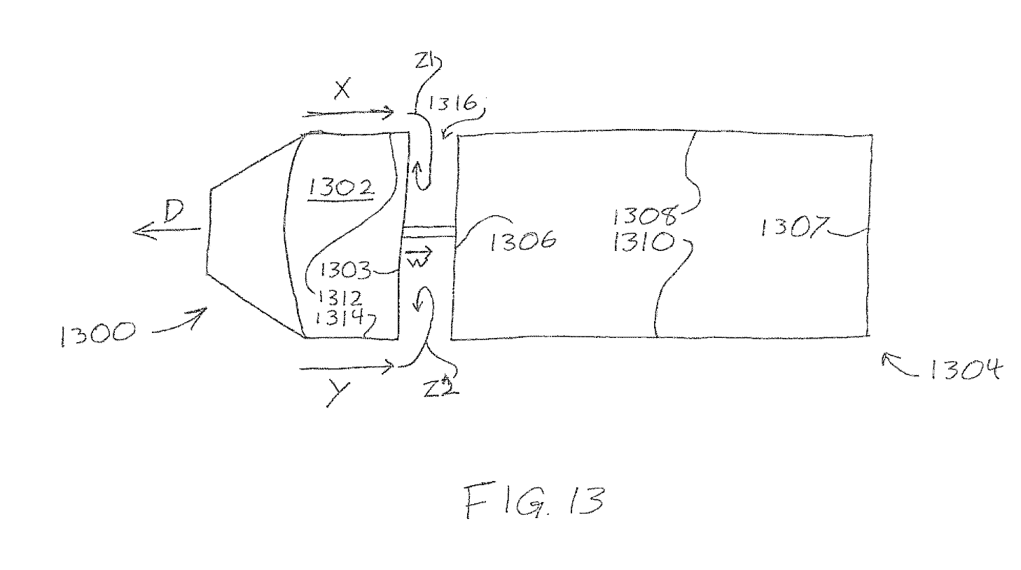

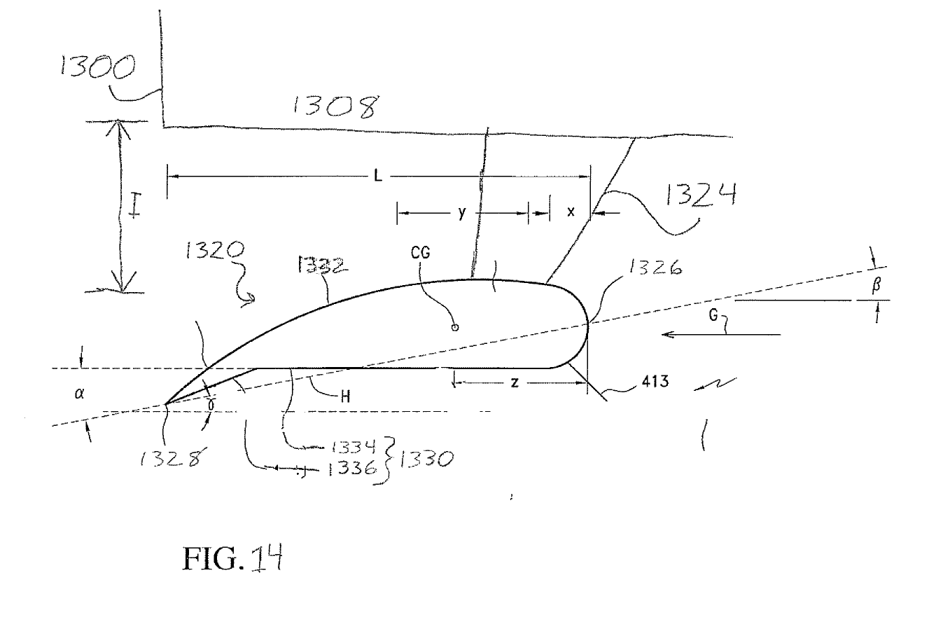

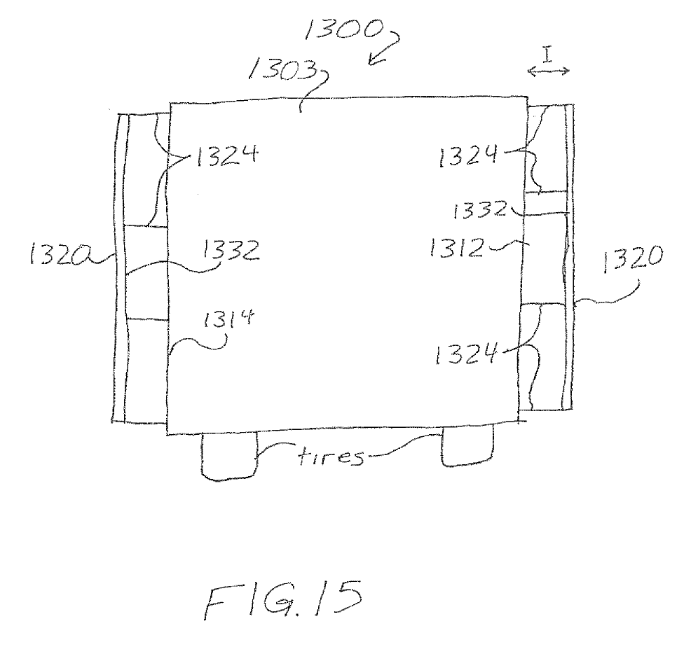

FIG. 12 shows a top view of a vehicle 100 having a door 1210 on its rear surface with a vane 401 attached thereto. As previously described, cable 1201 extends in a forward direction and connects the leading edge 402 of vane 401 to a side 104 of the vehicle at point of attachment 1201a. Cable 1204 extends vertically and connects the inner surface 405 of vane 401 to the rear edge of the side of the vehicle point of attachment 1204a. Since neither of cables 1201 or 1204 is connected to the rear of the vehicle, the horizontal distance between points of attachment 1201a and 1204a is relatively small, leading to reduced stability of the vane in an airstream. One or more cables 1301 is used to connect trailing edge 403 of vane 401 to a point of attachment 1301a on door jamb 1302, where door jamb 1302 surrounds door 1210 on the rear surface of vehicle 100.

While the foregoing discussion is primarily directed to unpowered vehicles being towed behind a separate, powered vehicle, the invention is not limited to such a configuration. It may equally well be applied to any powered vehicle having a substantially planar rear surface.

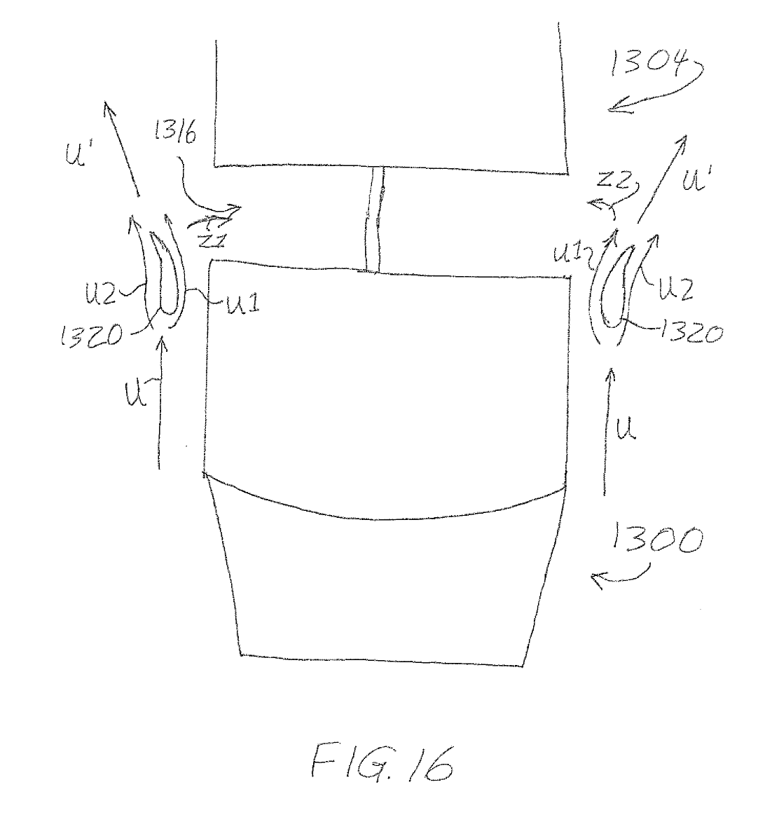

FIG. 13 shows a prior art airflow around a truck comprising a tractor 1300 and a trailer 1304. The tractor 1300 has a cab 1302, where the cab has a generally planar rear surface 1303. Tractor 1300 tows a trailer 1304 having a generally planar front surface 1306, a generally planar rear surface 1307, a right side 1308, and a left side 1310. The tractor 1300 and the trailer 1304 are moving in a forward direction D at a desired speed. Under these conditions, air moves, relative to vehicle tractor 1300, along the sides 1312 and 1314 in the direction of arrows X and Y, respectively. The flow of air in the direction X and the flow of air in the direction Y are drawn into the airspace 1316 between the tractor 1300 and the trailer 1304, in the direction of arrows Z1 and Z2. A zone of turbulent air is thereby created behind tractor rear surface 1303, where opposing airflows Z1 and Z2 meet. As a result, as the tractor 1300 moves forward in the direction of arrow D, a volume of turbulent low pressure air is carried in the airspace 1316 between the tractor 1300 and the trailer 1304. This volume of turbulent air creates drag on the vehicle by sucking in the direction of arrow W on surface 1303. The engine causing the vehicle to move forward must work harder to cause tractor 1300 and trailer 1304 to move at the desired speed in direction D while simultaneously overcoming the retarding force of drag in the direction of arrow W.

To overcome this problem, one embodiment of the invention, shown in FIG. 14, includes a vane 1320 of length L, where the vane 1320 is attached vertically to tractor 1300 by an attachment means. Vane 1320 may be cambered or non-cambered. The attachment means preferably includes at least a first bracket, brace or strut 1324 connecting an upper end of vane 1320, shown as a cambered vane in FIG. 14, to side 1312 of tractor 1300, and a second bracket, brace or strut 1324 connecting a lower end of vane 1320 to side 1312 of tractor 1300, as seen in FIG. 15. A second vane 1320 is attached to side 1314 of tractor 1300 by a second attachment means. If desired, additional brackets, braces or struts 1324 may connect a central portion of each vane 1320 to the sides of tractor 1300. Returning to FIG. 14, vane 1320 has a leading edge 1326 and a trailing edge 1328, an outer surface 1330, and an inner surface 1332. Length L is between 3 and 10 inches, preferably between 4 and 6 inches. Vane 1320 has an aerodynamic. center CG, where CG is positioned a defined distance Z behind leading edge 1326, where Z is greater than 0.15 L and less than 0.5 L, preferably between 0.35 L and 0.2 L, more preferably between 0.23 L and 0.3 L, most preferably about 0.26 L. Outer surface 1330 also includes a leading portion 1334 and a trailing portion 1336. Leading portion 1334 and trailing portion 1336 intersect with a defined angle of deflection α. Angle α is between 0° and 10°, preferably between 0° and 7°. Chordline H is defined by a line between the leading edge 1326 and the trailing edge 1328 of vane 1320. When the vane is directed into an airflow in direction G, the angle between the chordline H and airflow G is defined by angle β. The vane 1320 is preferably positioned so that the angle β ranges from a minimum of 0° (i.e., chordline H is parallel to airflow G) up to about 10°. Preferably, the angle β ranges from 0° up to about 5°. More preferably, the angle β ranges from 0° up to about 4°.

Again as shown in FIGS. 14 and 15, vanes 1320 are positioned on opposite sides 1312 and 1314 of tractor 1300 having a generally planar rear surface 1303. The vanes 1320 may be positioned so that vane the trailing edge of each vane 1320 either extends behind the rear surface 1303, or is generally coplanar with rear surface 1303. The inner surface 1332 of each vane 1320 is adjacent to a side of vehicle 1300, with a defined distance I separating surfaces vehicle 1300 from inner surfaces 1332. The inner surface 1332 of each vane 1320 is preferably about 0.25 to 2.0 inches from the surface of the vehicle, more preferably from 0.3 to 1.0 inch (identified as distance I). In one embodiment, the vane 1320 is oriented so that chordline H makes an angle γ with the vehicle ranging from a minimum of 0° (i.e., chordline H is parallel to airflow G) up to about 10°. Alternatively, angle γ may be viewed as the angle between chordline H and airflow G. Preferably, the angle γ ranges from 2° up to about 8°. More preferably, the angle γ ranges from 3° up to about 7°. In a further embodiment, the vane 1320 is oriented so that leading portion 1334 of outer surface 1330 is parallel to the side of vehicle 1300. The trailing portion 1336 of outer surface 1330 is angled away from vehicle 1300.

To avoid adding excess weight to the vehicle, the total weight of the vanes 1320 and the various brackets used as an attachment means may be less than 100 pounds, preferably less than fifty pounds, most preferably less than 20 pounds.

FIG. 16 shows a tractor 1300 pulling trailer 1304. The tractor has vanes 1320 mounted on sides 1312 and 1314 (brackets 1324 not shown). Under such conditions, air flows along the sides of vehicle 1320 in the direction of arrows U at a defined velocity u. As the airflow reaches vane 1320, it divides into a stream U1 of low pressure air traveling between the inner surface of vane 1320 and tractor 1300, and a stream of high pressure air U2 traveling over the outer surface of vane 1320. Air stream U2 is directed away from the side of tractor 1300 as it travels over vane 1320, due to the angled outer surface of vane 1320. Streams U1 and U2 recombine after flowing over vane 1320. Since the angled surface of vane 1320 has changed the direction of stream U2, streams U1 and U2 recombine to form a new stream flowing in the diection of arrow U′. The airflow in the direction of arrow U′ is directed away from the airspace 1316 between the tractor 1300 and the trailer 1304. As a result, there is less airflow into airspace 1316 in the direction of arrows Z1 and Z2. Streams U′ thus show reduced tendency to flow into airspace 1316 and create turbulence between the tractor 1300 and the trailer 1304, dramatically reducing pressure drag on tractor.

To maximize fuel savings from reduction of drag due to turbulance, vanes 1320 may be mounted on tractor 1300 and vanes 401, as shown in FIG. 4, may be mounted on trailer 1304. By combining both sets of vanes, enhanced fuel savings may be obtained. Vanes 1320 reduce drag from turbulent air between the tractor 1300 and the trailer 1304, while vanes 401 reduce drag from turbulent air behind the trailer 1304.

While the foregoing discussion is primarily directed to powered vehicles being used to tow a separate, unpowered vehicle, the invention is not limited to such a configuration. It may equally well be applied to any powered vehicle having a substantially planar rear surface. Vanes 1320 may be used on tractors towing trailers, but they are not limited to this use. Vanes 1320 may also be used on unpowered vehicles which tow additional unpowered vehicle, while themselves being towed or pushed by a third vehicle. In one embodiment, vanes 1320 may be installed on railroad cars to reduce drag on a first railroad car by turbulent air between the first railroad car and the railroad car immediately following. The energy savings for a train may be substantial, as a first railroad car is subject to drag from turbulent air between the first car and a second, immedately following car, and to drag from turbulent air between the second car and a third car following the second car, and so on. Drag from multiple vehicle being towed in sequence is additive. In general, vanes 1320 may be used on a powered vehicle towing an unpowered vehicle. Vanes 1320 may also be used on a powered vehicle operated in conjunction with a second powered vehicle. Vanes 1320 may further be used on a first unpowered vehicle which being pushed by a second powered vehicle.

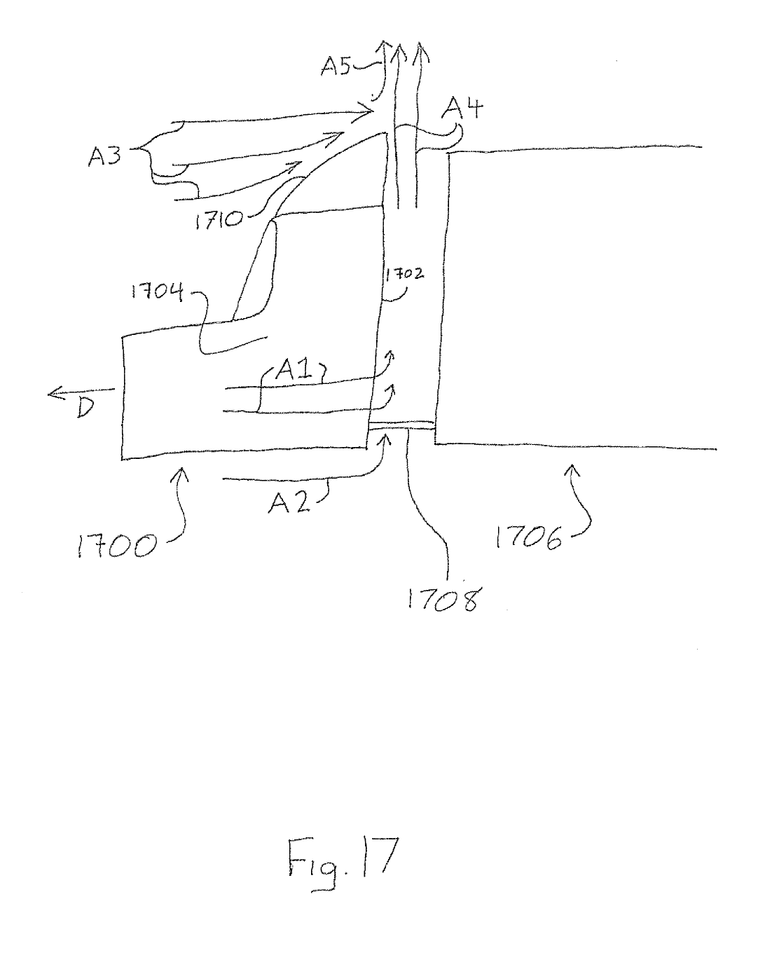

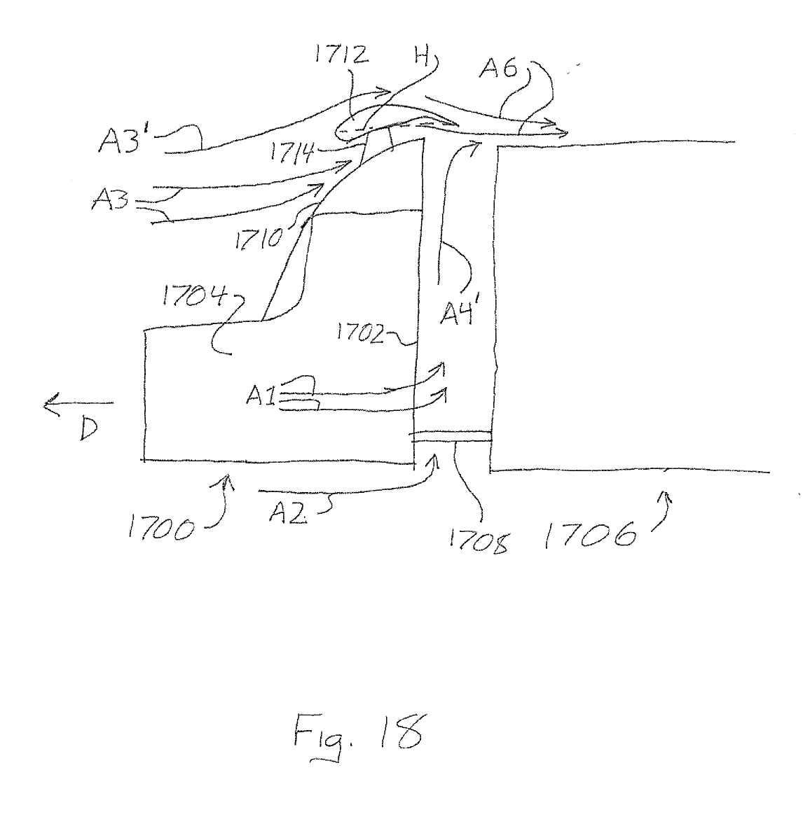

FIG. 17 shows another view of prior art airflow around a vehicle 1700, such as a tractor, having a generally planar rear surface 1702, a right side 1703 (not shown in FIG. 17), and a left side 1704, when vehicle 1700 moves in a forward direction D at a desired speed. Tractor 1700 pulls a trailer 1706 by means of trailer hitch 1708. Under these conditions, air moves, relative to tractor 1700, along the sides 1703 and 1704 in the direction of arrows A1; and along the bottom of tractor 1700 in the direction of arrow A2. Also, air travelling in the direction of arrows A3 creates a stream of fast-moving low-pressure air over the top of the tractor. Air between tractor 1700 and trailer 1706 is sucked upwards by the low-pressure air stream over the top of the tractor, in the direction of arrow A4. This creates a zone of low pressure air between tractor 1700 and trailer 1706. As airflows A1 and A2 reach the rear surface of tractor 1700, they are sucked into the low-pressure zone between tractor 1700 and trailer 1706, creating turbulence between tractor 1700 and trailer 1706. Also, as more air flows into the space between tractor 1700 and trailer 1706, the turbulent air in this region must flow out in the direction of arrows A4. Thus, not only is a zone of turbulent air created between tractor 1700 and trailer 1706, a zone of turbulent air is created by airflow in the direction of arrows A4 which can extend several feet above the top surface 1710 of the tractor 1700.

Many tractors are equipped with a streamlined top surface 1710, as depicted in FIG. 17. This is designed to reduce air resistance and increase fuel efficiency. However, use of a streamlined top surface 1710 is generally not effective, as seen in FIG. 17. Rather than flowing smoothly over top surface 1710 of tractor 1700 and then to trailer 1706, air travelling in the direction of arrows A3 encounters turbulent air flowing from the space between the tractor and the trailer in the direction of arrows A4. This causes airflow over the top of the tractor to become turbulent, and causes at least a portion of the air flowing over the tractor 1700 to flow upwards in the direction of arrow A5, rather than over trailer 1706. Thus, the drag on the tractor 1700 caused by wind resistance is based not merely on the cross sectional area of the tractor, as viewed from the front, but also on the volume of turbulent air above the tractor caused by airflow in the direction of arrows A4.

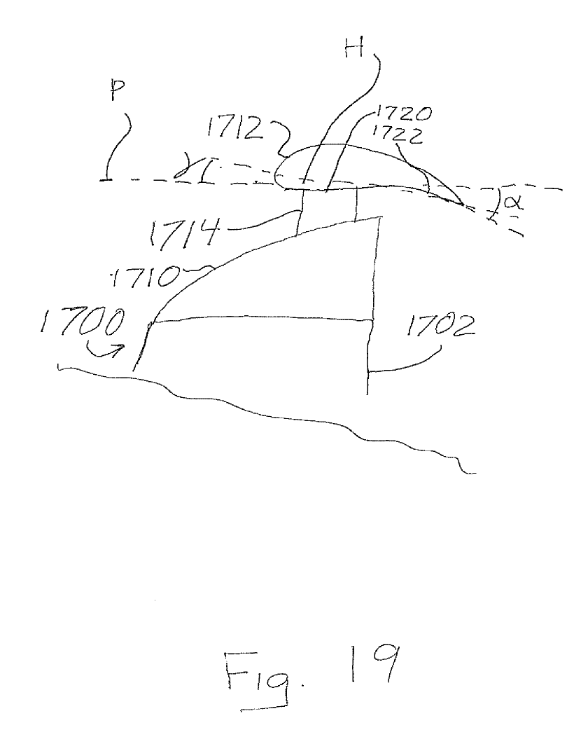

As seen in FIG. 18, this problem can be reduced or eliminated by positioning a vane or airfoil 1712 over the top surface 1710 of tractor 1700. The vane or airfoil 1712 is rigidly mounted to top surface 1710 by at least one bracket 1714. In various embodiments, the vane or airfoil 1712 is rigidly mounted to top surface 1710 by multiple brackets 1714. In various embodiments, the vane or airfoil 1712 is mounted to top surface 1710 by multiple brackets 1714, including at least a first bracket 1714 connected to a first end of vane 1712 and a second bracket 1714 connected to a second end of vane 1712 having chordline H. Vane 1712 may be an asymmetric cambered vane or a symmetric, non-cambered vane.

As seen in FIG. 18, vane 1712 reshapes airflow around tractor 1700. As before, air moves, relative to tractor 1700, along the sides 1703 and 1704 in the direction of arrows A1; and along the bottom of tractor 1700 in the direction of arrow A2. As airflows A1 and A2 reach the rear surface of tractor 1700, they are sucked into a zone of low pressure air between tractor 1700 and trailer 1706. As the vehicle moves forward in the direction of arrow D, air flows in the direction of arrows A3 and A3′ over top surface 1710. As air travelling in the direction of arrows A3 and A3′ reaches vane 1714, it divides. with air flowing in the direction of A3′ forming a stream of fast, low pressure air travelling over vane 1712 and air flowing in the direction of A3 forming a stream of higher pressure air travelling under vane 1712. As air travelling in the direction of arrows A3 and A3′ leaves vane 1712, it travels smoothly over trailer 1706, in the direction of arrows A6. Meanwhile, air in the turbulent zone between tractor 1700 and trailer 1706 flows upwardly in the direction of arrow A4′. Once air flowing in the direction of arrow A4′ reaches the top of the tractor 1710, it is diverted. This happens for two reasons. First, vane 1712 extends over at least a portion of the zone between tractor 1700 and trailer 1706, and physically blocks air flowing in the direction of arrow A4′ from continuing to travel upwards. Also, the airflow in the direction of arrows 6, leaving vane 1712, causes air traveling in the direction of arrow A4′ from the zone between tractor 1700 and trailer 1706 to be diverted into traveling over trailer 1706 rather than upwards.

In various embodiments, vane 1712 is a cambered vane mounted on a top surface 1710 of tractor 1700. In other embodiments. vane 1712 is a non-cambered vane. Vane 1712 has a lower surface with a leading portion 1720 and a trailing portion 1722, where the leading portion 1720 and the trailing portion 1722 intersect at an angle α, said angle α being between 0° and 10°, as shown in FIG. 19. The cambered vane 1712 has a chordline H. where the chordline H makes an angle γ with a horizontal plane P. The angle γ ranges from 0° to 10°, preferably from 2° to 8°, more preferably from 3° to 7°. The optimum angle may be dependent on the shape of the top surface 1710 of tractor 1700.

Although various embodiments of the invention have been described in detail, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims. In particular, the precise structure and design of the vanes as disclosed herein are capable of modifications which would be within the skill of a person of ordinary skill in the art having an advanced degree in aeronautical engineering.

What is claimed is:

1. An apparatus for affecting airflow around a first moving vehicle having a substantially planar rear surface, said rear surface of said first moving vehicle being connected to a second vehicle, said apparatus comprising:
a) a rigid vertical vane having a leading edge, a trailing edge, and an inner surface; and
b) at least one support connecting said inner surface of said vane to a side surface of said first vehicle;
wherein said vane reduces or prevents formation of a volume of turbulent air between said first moving vehicle and said second vehicle.

2. The apparatus of claim 1, wherein said at least one support comprises:
at least one first support rigidly connecting an upper portion of said vane to said side surface of said first vehicle; and
at least one second support rigidly connecting a lower portion of said vane to said side surface of said first vehicle.

3. The apparatus of claim 1, wherein said rigid vertical vane is a cambered vane having a leading edge, a trailing edge, a curved inner surface, and a flat outer surface.

4. The apparatus of claim 1, wherein said rigid vertical vane is a cambered vane having a leading edge, a trailing edge, a curved inner surface, and an outer surface,
said outer surface having a leading portion and a trailing portion, wherein said leading portion and said trailing portion intersect at an angle α, said angle α being between 0° and 10°.

5. The apparatus of claim 1, wherein said rigid vertical vane is a cambered vane having a chordline H,
wherein said chordline H makes an angle γ with said side surface of said first vehicle ranging from 2° to 8°.

6. The apparatus of claim 1, wherein said rigid vertical vane is a cambered vane having a chordline H,
wherein said chordline H makes an angle γ with an airflow flowing along said side surface of said first vehicle, said angle γ ranging from 2° to 8°,
wherein said cambered vane diverts said airflow away from said side surface of said first vehicle.

7. The apparatus of claim 6, wherein said angle γ between said chordline H and said airflow is adjustable.

8. The apparatus of claim 6, wherein said at least one support rigidly connects said inner surface of said vane to a side surface of said first vehicle at a distance L1 from said leading edge of said vane; said inner surface of said vane being curved;
wherein said angle γ between said chordline H and said airflow is adjustable by changing said distance L1.

9. The apparatus of claim 6, wherein said angle γ between said chordline H and said airflow is not adjustable.

10. The apparatus of claim 1, wherein the first moving vehicle is a powered vehicle.

11. The apparatus of claim 10, wherein the first moving vehicle is a tractor and the second vehicle is a trailer.

12. The apparatus of claim , wherein the first moving vehicle is a non-powered vehicle.

13. The apparatus of claim 12, wherein the first moving vehicle and the second vehicle are each railroad cars.

14. An apparatus for affecting airflow around a first moving vehicle having a substantially planar rear surface, said rear surface being connected with a second vehicle, said apparatus comprising:
a) a first rigid vertical vane and a second rigid vertical vane, each of said first and second vertical vanes having a leading edge, a trailing edge, and an inner surface;
b) at least one first attachment means rigidly connecting said first vertical vane to a first side surface of said vehicle;
c) at least one second attachment means rigidly connecting said second vertical vane to a second side surface of said vehicle; and
wherein said first and second vertical vanes reduce or prevent formation of a volume of turbulent air between said first moving vehicle and said second vehicle.

15. An apparatus for affecting airflow around a first moving vehicle having a substantially planar rear surface, said rear surface being connected with a second vehicle, said apparatus comprising:
a) a vertical cambered vane having a leading edge, a trailing edge, a curved inner surface, and a chordline H; and
b) at least one rigid support connected to said inner surface of said vane;
wherein said at least one support is adapted to rigidly connect said vane to said side surface so that said chordline H of said vane makes an angle γ with an airflow flowing along said side surface of said first vehicle, said angle γ ranging from 0° to 10°.

16. The apparatus of claim 15, wherein said at least one support rigidly connects said inner surface of said vane to a side surface of said first vehicle at a distance L1 from said leading edge of said vane;
wherein said angle γ between a chordline of said cambered vane and said airflow is adjustable by changing said distance L1.

17. A method of affecting airflow around a first moving vehicle having a substantially planar rear surface, said first moving vehicle towing a second vehicle, said method comprising:
a) rigidly connecting a first rigid vertical vane having a leading edge and a trailing edge to a first side surface of said first vehicle so that a chordline H of said first vane makes an angle γ with said first side surface of said first vehicle, said angle γ ranging from 0° to 10°; and
b) rigidly connecting a second rigid vertical vane having a leading edge and a trailing edge to a second side surface of said first vehicle so that a chordline H of said second vane makes a second angle γ with said second side surface of said first vehicle, said second angle γ ranging from 0° to 10°;
wherein said first and second vanes reduce or prevent formation of a volume of turbulent air between said first moving vehicle and said second vehicle.

18. An apparatus for affecting airflow around a first moving vehicle having a substantially planar rear surface, said rear surface being connected with a second vehicle, said apparatus comprising:
a) a rigid horizontal vane having a leading edge, a trailing edge, and a lower surface; and
b) at least one support connecting said lower surface of said vane to a top surface of said first vehicle;
wherein said vane reduces or prevents formation of a volume of turbulent air above said rear surface of said first moving vehicle.

19. The apparatus of claim 18, wherein said lower surface has a leading portion and a trailing portion, wherein said leading portion and said trailing portion intersect at an angle α, said angle α being between 0° and 10°.

20. The apparatus of claim 18, wherein said rigid horizontal vane is a cambered vane having a chordline H,
wherein said chordline H makes an angle γ with said top surface of said first vehicle, said angle γ ranging from 2° to 8°,
wherein said cambered vane redirects an airflow from a space between said first vehicle and second vehicle.

21. An apparatus of claim 1, wherein:
said first moving vehicle is a powered vehicle towing said second vehicle;
said first moving vehicle is a non-powered vehicle being pushed by said second vehicle; or
said first moving vehicle and said second vehicle are each non-powered vehicles being towed or pushed by a third vehicle.
